(19) United States
(12) Patent Application Publication
(10) Pub. No.: US 2026/0327374 A1
(43) Pub. Date: Oct. 22, 2026

(54) RECYCLED POLYESTER AND METHOD FOR MANUFACTURING THE SAME

(71) Applicants: Hyundai Motor Company, Seoul (KR); Kia Corporation, Seoul (KR)

(72) Inventors: Seongje Kim, Hwaseong-si (KR); Hongchan Jeon, Hwaseong-si (KR); Songjung Han, Daegu (KR); Iksung Choi, Daegu (KR); Iljae Lee, Daegu (KR)

(73) Assignees: Hyundai Motor Company, Seoul (KR); Kia Corporation, Seoul (KR)

(21) Appl. No.: 19/329,148

(22) Filed: Sep. 15, 2025

(30) Foreign Application Priority Data
Apr. 22, 2025 (KR) 10-2025-0052291

(51) Int. Cl. C08G 63/91; B29B 9/06; B29B 9/12; B29K 67/00; B29K 105/26; C08G 63/78; C08K 5/29; D01D 5/08; D01F 6/92

(52) U.S. Cl. CPC C08G 63/91; C08G 63/785; C08K 5/29; D01D 5/08; D01F 6/92; B29B 9/06; B29B 9/12; B29K 2067/00; B29K 2105/26; D10B 2331/04

(57) ABSTRACT

The present disclosure relates to a recycled polyester and a method for manufacturing the same. According to embodiments of the present disclosure, a recycled polyester is provided, comprising 100 parts by weight of polyester resin, 0.3 parts by weight to 1.3 parts by weight of an epoxy-based chain extender, and 0.1 parts by weight to 0.5 parts by weight of a carbodiimide-based chain extender.

### CROSS-REFERENCE TO RELATED APPLICATION

This present application claims the benefit of priority to Korean Patent Application No. 10-2025-0052291, filed on Apr. 22, 2025, in the Korean Intellectual Property Office, the entire disclosure of which is incorporated herein by reference in its entirety.

### FIELD

The present disclosure relates to a recycled polyester and a method for manufacturing the same.

### BACKGROUND

Polyester fibers are widely utilized across various industrial and textile sectors owing to their remarkable durability, versatility, and wide-ranging applications. Nonetheless, the escalating environmental concerns associated with global degradation have prompted a significant shift towards sustainable materials. In response to these challenges, recycled polyester, which is produced by repurposing waste plastics, has received considerable attention for its potential as an eco-friendly alternative. Additionally, fibers derived from recycled polyester represent a sustainable solution that not only reduces plastic waste but also mitigates the environmental impact of textile production. Thus, the adoption of recycled polyester and its subsequent fiber products signifies a noteworthy advancement in the pursuit of sustainable practices within the textile industry.

Nonetheless, in the realm of fiber manufacturing processes that utilize recycled polyester, one notable challenge is the difficulty in achieving adequate molecular weight, which subsequently leads to diminished stability during the fiber spinning process. The intrinsic viscosity (IV) of polyester is a important parameter that significantly influences both the mechanical properties of the fibers and their spinnability. Current methodologies in the recycling and manufacturing of polyester fibers have seen the implementation of various strategies aimed at enhancing molecular weight. Nonetheless, achieving uniform control over viscosity has proven to be particularly challenging. As a result, several complications have emerged during the fiber spinning process, including instances of fiber breakage and a marked reduction in the uniformity of the produced fibers. These issues underscore the need for continued innovation and refinement in the recycling processes of polyester to enhance the overall quality and performance of recycled fibers.

Accordingly, there is a need for improved technology that is capable of effectively increasing the molecular weight of recycled polyester while manufacturing stable fibers during fiber spinning.

### SUMMARY

The present disclosure provides a recycled polyester having increased molecular weight and improved spinnability, and a method for manufacturing the same.

The present provides a recycled polyester applicable to various fiber processes such as multifilament, nonwoven fabric, and staple fiber, and a method for manufacturing the same.

The present provides a method for manufacturing high-quality recycled polyester fiber.

One aspect of the present disclosure provides a recycled polyester comprising 100 parts by weight of polyester resin, 0.3 parts by weight to 1.3 parts by weight of an epoxy-based chain extender, and 0.1 parts by weight to 0.5 parts by weight of a carbodiimide-based chain extender.

In embodiments, the recycled polyester has an intrinsic viscosity increased by at least 25% compared to the polyester resin.

In embodiments, the epoxy-based chain extender has 3 to 15 epoxy functional groups per molecule.

In embodiments, the epoxy-based chain extender includes a glycidyl acrylate-based polymer.

In embodiments, the molecular weight of the epoxy-based chain extender ranges from 3,000 g/mol to 10,000 g/mol.

In embodiments, the carbodiimide-based chain extender includes monomeric carbodiimide, polycarbodiimide, or a combination thereof.

In embodiments, the carbodiimide-based chain extender includes an aromatic carbodiimide-based compound.

Another aspect of the present disclosure provides a method for manufacturing a recycled polyester, comprising preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender, and melting and extruding the mixture.

In embodiments, the extruding is performed at a screw speed of 100 rpm to 300 rpm.

In embodiments, the extruding is performed at a temperature of 260 °C to 300 °C.

Still another aspect of the present disclosure provides a method for manufacturing a recycled polyester fiber, comprising preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender, manufacturing a recycled polyester by melting and extruding the mixture, and spinning the recycled polyester.

In embodiments, the spinning is performed at a temperature of 260 °C to 300 °C.

In embodiments, the spinning is performed at a speed of 100 m/min to 1,000 m/min.

The recycled polyester according to embodiments of the present disclosure has an increased molecular weight and improved spinnability.

Further, the recycled polyester has improved spinnability for fiber applications, making it applicable to various fiber processes such as multifilament, nonwoven fabric, and staple fiber.

In addition, use of the recycled polyester enables stable manufacture of high-quality recycled polyester fiber.

### DETAILED DESCRIPTION

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

Singular forms “a,” “an,” and “the” used in the specification and the appended claims are intended to include plural referents unless the context clearly dictates otherwise.

In addition, numerical ranges used in this specification includes the lower limit and upper limit and all values within the range, increments logically derived from the form and width of the defined range, all doubly limited values, and all possible combinations of upper and lower limits of numerical ranges limited in different forms. Unless specifically defined in this specification, values outside the defined numerical ranges that may occur due to experimental error or rounding off of values are also included within the defined numerical ranges.

Furthermore, reference throughout the specification to “including” or “comprising” a constituent element means that, unless specifically stated to the contrary, other constituent elements are not excluded and is included.

Embodiments of the present disclosure relate to a recycled polyester and a method for manufacturing the same. The recycled polyester has improved spinnability while having an increased molecular weight, making it applicable to various fiber processes such as multifilament, nonwoven fabric, and staple fiber.

A recycled polyester according to embodiments of the present disclosure includes 100 parts by weight of polyester resin, 0.3 parts by weight to 1.3 parts by weight of an epoxy-based chain extender, and 0.1 parts by weight to 0.5 parts by weight of a carbodiimide-based chain extender.

By including the two types of chain extenders described above, the recycled polyester has an effectively increased molecular weight and improved mechanical properties. In addition, spinnability is improved in fiber-forming processes using the recycled polyester, thereby enabling more uniform fiber formation and maintaining fiber quality through stable spinning. Accordingly, the efficiency of the spinning process is improved compared to existing recycled polyester materials, and both uniformity and strength of the fibers is secured, enhancing applicability in various industrial fields.

The recycled polyester includes a polymer in which molecular weight is increased by reacting the polyester resin with the two types of chain extenders. The molecular weight increase reaction may proceed differently depending on the characteristics of the chain extenders.

The carbodiimide-based chain extender may form urea bonds as carbodiimide (—N═C═N—) functional groups bind with carboxyl groups (—COOH) at polyester terminals through nucleophilic attack reactions. In this process, molecular weight increases as cross-linking is formed. Through such reaction, the number of free terminal groups in the polyester polymer is reduced, and mechanical properties is improved as bonds are formed between polymer chains.

The epoxy-based chain extender includes epoxy functional groups and reacts with carboxyl groups (—COOH) and hydroxyl groups (—OH) at polyester terminals. As the reaction proceeds, the three-membered ring structure of the epoxy undergoes ring-opening and may form new ester bonds or ether bonds by binding with polyester terminal groups. In this process, molecular weight increases as cross-linking bonds are formed between polyester molecules, and the viscosity of the polyester polymer increases. Further, processability is improved, and spinning stability in the fiber formation process is enhanced.

Therefore, by using the two types of chain extenders, the recycled polyester has improved mechanical properties and spinnability compared to existing polyester materials.

The polyester resin includes polyethylene terephthalate (PET), polybutylene terephthalate (PBT), polytrimethylene terephthalate (PTT), polycyclohexylene dimethylene terephthalate (PCT), polycarbonate (PC), polyamide (PA), or a combination thereof. For example, the polyester resin includes polyethylene terephthalate.

The polyester resin includes waste polyester resin, virgin polyester resin, or a combination thereof. For example, the polyester resin includes 10 wt % to 90 wt % of waste polyester resin and 10 wt % to 90 wt % of virgin polyester resin. For example, the polyester resin includes 50 wt % or more, 75 wt % or more, 90 wt % or more, or 100 wt % of waste polyester resin. Through this, even when using a high proportion of recycled materials, uniformity and spinning stability of fibers in the spinning process is secured.

The waste polyester resin is obtained through post-consumer recycled (PCR) or post-industrial recycled (PIR) processes. Post-consumer recycled refers to recycling to prevent waste plastics such as water bottles and beverage bottles used in daily life from being treated as waste. Post-industrial recycled refers to recycling waste or unused plastics generated during manufacturing processes.

Examples of the waste polyester resin includes low-grade waste polyester resin, recycled uniform material polyester resin, and the like, but are not limited thereto.

For example, the waste polyester resin is in the form of flakes manufactured through washing and crushing processes. When the waste polyester resin is in flake form, the flake size is 0.5 mm to 5 mm, but is varied as long as the properties of the present disclosure can be implemented.

The polyester resin has a moisture content of 1 wt % or less. When the moisture content satisfies the above range, recycled polyester having improved mechanical properties is provided. The moisture content is measured using a moisture tester, and the measurement method may adopt the Karl Fischer moisture measurement method, and the measurement device may adopt a Swiss Metrohm 831 type Karl Fischer moisture tester.

The polyester resin has a melting point of 250 °C to 270 °C or 255 °C to 265 °C. When the melting point falls within the above range, recycled polyester having improved mechanical properties is provided.

In embodiments, the recycled polyester has an intrinsic viscosity increased by at least 25% compared to the polyester resin. In various exemplary embodiments, the recycled polyester has an intrinsic viscosity increased by 30% or more compared to the polyester resin; however, the upper limit is not limited and is 60% or less, 50% or less, or 45% or less. Here, the intrinsic viscosity of the reference polyester resin is measured after melt extrusion at a screw speed of 200 rpm and a temperature of 280 °C. The intrinsic viscosity is measured according to ASTM D 4603.

In embodiments, the recycled polyester has an intrinsic viscosity increased by 0.1 dL/g to 0.25 dL/g, or 0.133 dL/g to 0.220 dL/g, compared to the polyester resin. The recycled polyester has an intrinsic viscosity of 0.45 dL/g to 0.85 dL/g, or 0.5 dL/g to 0.8 dL/g.

The increase in intrinsic viscosity of the recycled polyester reflects an increase in molecular weight, and improved mechanical properties is achieved by using the two types of chain extenders in the specific amounts described above. Accordingly, uniform fiber formation is achieved during fiber spinning. Further, the recycled polyester is designed to maintain high intrinsic viscosity without compromising processability, and is applied to various polyester-based fiber products.

In embodiments, the recycled polyester has shapes such as chips, pellets, flakes, powder, film, or sheets, but is not limited thereto and is provided in various forms such as blocks, solutions, foam, and the like. Thus, the present disclosure is not limited to specific shapes, and various modifications and applications are possible depending on the intended use and purpose.

In embodiments, the epoxy-based chain extender is included in the recycled polyester in an amount of 0.3 parts by weight to 1.3 parts by weight based on 100 parts by weight of polyester resin. Further, the carbodiimide-based chain extender is included in the recycled polyester in an amount of 0.1 parts by weight to 0.5 parts by weight based on 100 parts by weight of polyester resin. By using the epoxy-based chain extender together with the carbodiimide-based chain extender in the above amounts, the molecular weight is effectively increased and mechanical properties is improved. If the content of either of the chain extenders exceeds the upper limit of its respective range, excessive cross-linking may occur, causing the viscosity of the recycled polyester to increase excessively. As a result, melt flowability may deteriorate, which may lead to unsmooth filament formation during the spinning process and issues such as fiber breakage or reduced fiber uniformity. Meanwhile, if the content of either chain extender is below the lower limit of its respective range, the chain extension reaction may not sufficiently proceed, and the effect of increasing molecular weight is limited. As a result, the mechanical properties may not be sufficiently improved, and it is difficult to secure the desired viscosity during the spinning process, making uniform fiber formation difficult or causing a reduction in spinning stability.

In various exemplary embodiments, the epoxy-based chain extender is included in an amount of 0.4 parts by weight to 1.2 parts by weight, 0.5 parts by weight to 1.0 parts by weight, or 0.6 parts by weight to 0.8 parts by weight. The carbodiimide-based chain extender is included in an amount of 0.15 parts by weight to 0.45 parts by weight or 0.2 parts by weight to 0.4 parts by weight.

The epoxy-based chain extender has 3 to 15 epoxy functional groups per molecule, 5 to 12, 6 to 10, or 8 to 10 epoxy functional groups. By satisfying the above range, the molecular weight is effectively increased and mechanical properties is improved. Exceeding the above range for epoxy functional groups results in excessive cross-linking formation, increasing viscosity and degrading melt flowability. Conversely, having fewer functional groups than the above range results in insufficient chain extension reaction, and the molecular weight increase effect is limited.

The epoxy-based chain extender includes a glycidyl acrylate-based polymer, and for example, includes a styrene-acrylate-glycidyl methacrylate copolymer. Through this, the molecular weight is more effectively increased and mechanical properties is significantly improved.

When the epoxy-based chain extender is a polymer, the molecular weight ranges from 3,000 g/mol to 10,000 g/mol, 5,000 g/mol to 10,000 g/mol or 7,000 g/mol to 10,000 g/mol. Through this, the molecular weight is more effectively increased and mechanical properties is significantly improved.

The carbodiimide-based chain extender includes monomeric carbodiimide, polycarbodiimide, or a combination thereof. Monomeric carbodiimide has a low molecular weight and reacts quickly with terminal groups of polyester, and increases molecular weight through a chain extension reaction. Accordingly, a viscosity increase is effectively achieved, while maintaining appropriate melt flowability during the spinning process. Polycarbodiimide has a relatively high molecular weight and has multiple reaction sites, enabling more uniform chain extension and cross-linking formation. Through this, the mechanical properties of the recycled polyester is improved, and uniformity and stability of the fibers is enhanced during the spinning process.

The carbodiimide-based chain extender includes an aromatic carbodiimide-based compound. Due to their aromatic structure, aromatic carbodiimide-based compounds may exhibit increased thermal and chemical stability, and mechanical strength is improved as a result of enhanced intermolecular interactions. These characteristics may reduce viscosity variation even in high-temperature environments during the spinning process and may contribute to stable fiber formation.

The present disclosure may further provide a method for manufacturing a recycled polyester, comprising preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender, and melting and extruding the mixture.

The polyester resin, epoxy-based chain extender, carbodiimide-based chain extender, and recycled polyester are the same as described above, so detailed description is omitted.

First, a mixture is prepared by mixing 100 parts by weight of polyester resin, 0.3 parts by weight to 1.3 parts by weight of an epoxy-based chain extender, and 0.1 parts by weight to 0.5 parts by weight of a carbodiimide-based chain extender. At this time, the mixing is performed using mixing equipment such as a Super Mixer, a ribbon blender, a twin shaft mixer, or a ball mill. For example, the stirring speed during mixing is adjusted in the range of 100 rpm to 1,000 rpm.

By mixing the two types of chain extenders with the polyester resin at a specific weight ratio, the chain extenders is uniformly distributed at a ratio suitable for increasing molecular weight and improving mechanical properties, thereby securing homogeneity of the mixture.

Next, the mixture is melted and extruded. The extruded molten polyester is discharged in the form of strands, which may then be cooled, stabilized, and cut into pellets to manufacture the recycled polyester.

The extruding is performed at a screw speed of 100 rpm to 300 rpm. By setting the screw speed within the above range, uniform strand formation is possible, and chain extension reaction is smoothly achieved while maintaining stable operation of the extrusion equipment. If the screw speed is less than 100 rpm, strand formation is non-uniform and cutting may occur during cooling. If the screw speed exceeds 300 rpm, the extrusion load increases, causing equipment stoppage or backflow. Further, back pressure increases due to excessive discharge, and die swell and strand deformation due to shear may occur.

The extruding is performed at a temperature of 260 °C to 300 °C. By maintaining the extrusion temperature within the above range, uniform strands is formed and stable fiber formation is achieved in subsequent spinning processes. If the extrusion temperature is less than 260 °C, melt viscosity increases, resulting in discharge defects and increased expansion, which in turn may raise the extrusion load. If the extrusion temperature exceeds 300 °C, melt viscosity is excessively low, leading to excessive discharge and increased flowability, making strand formation difficult. Further, carbonization may occur due to excessive heat, resulting in degradation of polyester properties and a decrease in intrinsic viscosity.

The extruding is performed at an extrusion load in the range of 10 A to 30 A. Here, the extrusion load means the current load generated in the process of transporting and processing raw materials in the extruder, and is an indicator showing a load state of the extruder motor. If the extrusion load is less than 10 A, the supplied raw material amount is insufficient or extrusion force is insufficient, making uniform extrusion difficult. Conversely, if the extrusion load exceeds 30 A, the viscosity of raw materials increases excessively or normal processing is difficult due to overload of the extruder.

The extrusion rate is 10 kg/hr to 30 kg/hr. The extrusion rate refers to the amount of molten polyester discharged from the extruder per unit time, and is an important factor determining productivity and whether chain extension reaction proceeds sufficiently. If the extrusion rate is less than 10 kg/hr, productivity is reduced and thermal decomposition may occur due to prolonged residence time. If the extrusion rate exceeds 30 kg/hr, the residence time of the molten polyester is too short, which may prevent sufficient chain extension reaction and make it difficult to manufacture recycled polyester with uniform quality.

By maintaining the screw speed, extrusion temperature, extrusion load, and extrusion rate within the above-described ranges, the effect of molecular weight increase is enhanced. Further, in the fiber formation process using the recycled polyester, spinnability is improved to enable uniform fiber formation, and stable spinning is achieved to maintain fiber quality.

According to a method for manufacturing recycled polyester according to embodiments, carbon emissions is significantly reduced compared to existing solid-state polymerization methods. For example, carbon emissions is approximately four times lower than in solid-state polymerization methods, resulting in a significant reduction in annual carbon dioxide (CO₂) generation. Based on actual production volume comparisons, solid-state polymerization methods emit approximately 1.05 times more greenhouse gases. When normalized to the same production output, the difference becomes even greater, with solid-state polymerization methods producing about 4.22 times more greenhouse gas emissions.

As such, the present disclosure may maintain the quality of recycled polyester while reducing energy consumption compared to existing methods, and through this, an environmentally friendly production process is implemented. Furthermore, by reducing carbon emissions, the present disclosure may contribute to the sustainable development of the textile industry and support efforts to achieve carbon neutrality goals.

The present disclosure may further provide a method for manufacturing a recycled polyester fiber, comprising preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender, manufacturing a recycled polyester by melting and extruding the mixture, and spinning the recycled polyester. Here, preparing the mixture and manufacturing recycled polyester are the same as described above, so detailed description is omitted.

The spinning of the recycled polyester is performed at a temperature of 260 °C to 300 °C or 280 °C to 300 °C. When melt spinning is performed in this temperature range, the polyester may maintain sufficient fluidity to enable uniform fiber formation, and stable fiber flow is secured during the spinning process. Furthermore, smooth extrusion through the spinning nozzles is achieved, thereby preventing fiber breakage and non-uniform fiber formation. The spinning is performed at a speed of 100 m/min to 1,000 m/min or 150 m/min to 500 m/min.

When using the recycled polyester, unlike existing recycled materials, an increase in molecular weight is achieved while also enabling stable formation of recycled polyester fiber with high productivity.

The method may further include drawing after spinning the recycled polyester. The drawing process is performed to control fiber strength and elongation and to enhance mechanical properties by improving molecular orientation. The drawing process is carried out using commonly known methods in the relevant technical field. For example, the drawing process is performed using godet rollers. The draw ratio of the drawing process is 1.5 to 5.0 or 1.5 to 3.0, but is not particularly limited thereto.

Hereinafter, examples will be specifically illustrated and described. However, the following examples are only illustrative, and the technology described in this specification is not limited thereto.

### Example 1

A mixture was prepared by preliminarily stirring 100 parts by weight of low-grade PET waste resources (C-grade r-PET flakes), 0.7 parts by weight of Joncryl® ADR 4468, and 0.3 parts by weight of ZIKA-AH362 (bis(2,6-diisopropylphenyl) carbodiimide) manufactured by ZIKO in a super mixer at 500 rpm for 5 minutes. Here, the low-grade PET waste resources were 4 mm flakes obtained by washing and crushing post-consumer waste PET bottles, and had a melting point of 260 °C and residual moisture content of 1 wt % or less.

The mixture was supplied to a twin-screw extruder and then melt-extruded at a screw speed of 200 rpm and temperature of 280 °C, and strands were manufactured under conditions of an extrusion rate of 20 kg/hr and an extrusion load of 28 A. The strands were discharged through an 80/200/80 mesh filter. Recycled polyester chips were manufactured by cutting the discharged strands.

### Example 2

Recycled polyester chips were manufactured in the same manner as in Example 1, except that 10 parts by weight of low-grade PET waste resources and 90 parts by weight of uniform material waste PET were used instead of 100 parts by weight of low-grade PET waste resources, and strands were manufactured under conditions of extrusion load 23 A and 80/80 mesh filter. Here, uniform material waste PET collected from waste vehicles was used.

### Comparative Examples 1-1 to 1-9

The same procedure as Example 1 was performed except that the content of chain extenders used and extrusion conditions were as described in Table 1 below.

TABLE 1

| | | | | Extru- | |
|---|---|---|---|---|---|
| | Joncryl | Carbodiimide | | sion | Extru- |
| | content | content | Screw | temper- | sion |
| | (parts by | (parts by | speed | ature | load |
| | weight) | weight) | (rpm) | (°C) | (A) |
| Example 1 | 0.7 | 0.3 | 200 | 280 | 28 |
| Comparative | 0 | 0 | 200 | 280 | 19-20 |
| Example 1-1 | | | | | |
| Comparative | 1.4 | 0.3 | 200 | 280 | 26 |
| Example 1-2 | | | | | |
| Comparative | 0.2 | 0.3 | 200 | 280 | 26 |
| Example 1-3 | | | | | |
| Comparative | 0.7 | 0.05 | 200 | 280 | 26 |
| Example 1-4 | | | | | |
| Comparative | 0.7 | 0.6 | 200 | 280 | 27 |
| Example 1-5 | | | | | |
| Comparative | 1.0 | 0 | 200 | 280 | 29 |
| Example 1-6 | | | | | |
| Comparative | 0.7 | 0.3 | 90 | 280 | 12-14 |
| Example 1-7 | | | | | |
| Comparative | 0.7 | 0.3 | 310 | 280 | 50-62 |
| Example 1-8 | | | | | |
| Comparative | 0.7 | 0.3 | 200 | 255 | — |
| Example 1-9 | | | | | |
| Comparative | 0.7 | 0.3 | 200 | 305 | 15-17 |
| Example 1-10 | | | | | |

### Comparative Examples 2-1 to 2-5

The same procedure as Example 2 was performed except that the content of chain extenders used and extrusion conditions were as described in Table 2 below.

TABLE 2

| | Joncryl | Carbodiimide | |
|---|---|---|---|
| | content | content | Extrusion |
| | (parts by | (parts by | load |
| | weight) | weight) | (A) |
| Example 2 | 0.7 | 0.3 | 23 |
| Comparative | 0 | 0 | 18-19 |
| Example 2-1 | | | |
| Comparative | 1.4 | 0.3 | 27 |
| Example 2-2 | | | |
| Comparative | 0.2 | 0.3 | 22 |
| Example 2-3 | | | |
| Comparative | 0.7 | 0.05 | 22 |
| Example 2-4 | | | |
| Comparative | 0.7 | 0.6 | 25 |
| Example 2-5 | | | |

### Experimental Example

The appearance characteristics of strands, intrinsic viscosity of recycled polyester chips, and spinnability of recycled polyester chips produced in the examples and comparative examples were measured by the following methods, and the results are shown in Table 3 below.

(1) Appearance characteristics: Strands were visually observed and judged according to the following criteria:
Excellent: Uniform strands are formed while maintaining constant discharge amount and discharge rate from the die during extrusion
Fair: Swelling occurs from the die during extrusion, showing differences in strand thickness or shape
Poor: Discharge is non-uniform, or strand formation is not properly achieved

(2) Intrinsic viscosity (IV): Measured according to ASTM D 4603. Specifically, recycled polyester chips manufactured in the examples or comparative examples were dissolved in solvents at various concentrations, and then viscosity was measured using an Ubbelohde viscometer at a constant temperature. Subsequently, the intrinsic viscosity was calculated by extrapolation using viscosity-concentration graphs. At this time, a mixed solvent of phenol and 1,2-dichlorobenzene (DCB) in a 1:1 weight ratio was used as the solvent.

Further, for each of Example 1 and Comparative Examples 1-2 to 1-10, the difference (ΔIV) and increase rate from the intrinsic viscosity of Comparative Example 1-1 were calculated. For each of Example 2 and Comparative Examples 2-2 to 2-5, the difference (ΔIV) and increase rate from the intrinsic viscosity of Comparative Example 2-1 were calculated.

(3) Spinnability: Spinning was performed under the conditions described below, and cases where spinning was performed smoothly were marked as ‘O’, and cases where fibers broke and normal spinning was not achieved were marked as ‘X’. Specifically, recycled polyester chips manufactured in the examples or comparative examples were melted at 280 °C and then spun using a multi-hole spinning nozzle (192 Hole Spinneret) with a diameter of 0.4 mm. Subsequently, the spun fibers were processed at 150 m/min speed in a first godet roller (GR1) and then additionally drawn at 300 m/min speed in a second godet roller (GR2). At this time, the draw ratio was set to 2.0, and finally winding was performed at a speed of 250 m/min.

TABLE 3

| | Appearance | | | IV | |
|---|---|---|---|---|---|
| | character- | IV | ΔIV | increase | Spinna- |
| | istics | (dL/g) | (dL/g) | rate (%) | bility |
| Example 1 | Excellent | 0.753 | 0.220 | 41.28 | ◯ |
| Comparative | Excellent | 0.533 | (Reference) | — | ◯ |
| Example 1-1 | | | | | |
| Comparative | Poor | 0.789 | 0.256 | 48.03 | X |
| Example 1-2 | | | | | |
| Comparative | Excellent | 0.554 | 0.021 | 3.94 | ◯ |
| Example 1-3 | | | | | |
| Comparative | Fair | 0.597 | 0.064 | 12.01 | X |
| Example 1-4 | | | | | |
| Comparative | Poor | 0.755 | 0.222 | 41.65 | X |
| Example 1-5 | | | | | |
| Comparative | Poor | 0.795 | 0.262 | 49.16 | X |
| Example 1-6 | | | | | |
| Comparative | Poor | 0.737 | 0.204 | 38.27 | X |
| Example 1-7 | | | | | |
| Comparative | Poor | 0.662 | 0.129 | 24.20 | X |
| Example 1-8 | | | | | |
| Comparative | Poor | — | — | — | X |
| Example 1-9 | | | | | |
| Comparative | Poor | 0.713 | 0.180 | 33.77 | X |
| Example 1-10 | | | | | |
| Example 2 | Excellent | 0.539 | 0.133 | 32.76 | ◯ |
| Comparative | Fair | 0.406 | (Reference) | — | X |
| Example 2-1 | | | | | |
| Comparative | Poor | 0.582 | 0.176 | 43.35 | X |
| Example 2-2 | | | | | |
| Comparative | Excellent | 0.457 | 0.051 | 12.56 | X |
| Example 2-3 | | | | | |
| Comparative | Fair | 0.482 | 0.076 | 18.72 | X |
| Example 2-4 | | | | | |
| Comparative | Poor | 0.553 | 0.147 | 36.21 | X |
| Example 2-5 | | | | | |

Referring to Table 3, it can be seen that Examples 1 and 2 had a molecular weight increase of 0.133 to 0.220 dL/g compared to the reference, and normal spinning was possible.

In contrast, Comparative Example 1-1, which did not use any chain extender, had low intrinsic viscosity. Comparative Examples 1-2 and 1-5, where either the content of epoxy-based chain extender was outside the range of 0.3 wt % to 1.3 wt % or the content of carbodiimide-based chain extender was outside the range of 0.1 wt % to 0.5 wt %, had low intrinsic viscosity or normal spinning was not possible. Comparative Example 1-6, which used only the epoxy-based chain extender, exhibited an excellent intrinsic viscosity increase effect, but fibers broke and normal spinning was not achieved. Comparative Examples 1-7 and 1-10, in which the screw speed was outside the range of 100 rpm to 300 rpm or the extrusion temperature was outside the range of 260 °C to 300 °C, also did not achieve normal spinning. Particularly, in Comparative Example 1-9, strands were not properly formed.

Comparative Example 2-1, without any chain extender, had low intrinsic viscosity and normal spinning was not possible. Comparative Examples 2-2 to 2-5, where the content of epoxy-based chain extender or carbodiimide-based chain extender was outside the specific ranges, also had low intrinsic viscosity or normal spinning was not possible.

Through these results, it can be seen that the recycled polyester according to embodiments may exhibit an excellent molecular weight increase effect and spinnability, making it applicable to various fiber processes such as multifilament, nonwoven fabric, and staple fiber.

Although the scope of the present disclosure has been described by specific matters and limited embodiments in the present specification, the embodiments are provided only for assisting the understanding of the present disclosure more generally, and the present disclosure is not limited to the embodiments disclosed herein. Various modifications and changes is made to the embodiments by those skilled in the art to which the present disclosure pertains from the description and shall be understood as being included in the embodiments disclosed herein.

What is claimed is:

1. A recycled polyester comprising 100 parts by weight of polyester resin, 0.3 parts by weight to 1.3 parts by weight of an epoxy-based chain extender, and 0.1 parts by weight to 0.5 parts by weight of a carbodiimide-based chain extender.

2. The recycled polyester of claim 1, wherein the recycled polyester has an intrinsic viscosity increased by at least 25% compared to the polyester resin.

3. The recycled polyester of claim 1, wherein the epoxy-based chain extender has 3 to 15 epoxy functional groups per molecule.

4. The recycled polyester of claim 1, wherein the epoxy-based chain extender comprises a glycidyl acrylate-based polymer.

5. The recycled polyester of claim 4, wherein the molecular weight of the epoxy-based chain extender ranges from 3,000 g/mol to 10,000 g/mol.

6. The recycled polyester of claim 1, wherein the carbodiimide-based chain extender comprises monomeric carbodiimide, polycarbodiimide, or a combination thereof.

7. The recycled polyester of claim 1, wherein the carbodiimide-based chain extender comprises an aromatic carbodiimide-based compound.

8. A method for manufacturing a recycled polyester, comprising:
preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender; and
melting and extruding the mixture.

9. The method of claim 8, wherein the extruding is performed at a screw speed of 100 rpm to 300 rpm.

10. The method of claim 8, wherein the extruding is performed at a temperature of 260 °C to 300 °C.

11. A method for manufacturing a recycled polyester fiber, comprising:
preparing a mixture including 100 parts by weight of polyester resin, 0.3 parts by weight to 1.3 parts by weight of an epoxy-based chain extender, and 0.1 parts by weight to 0.5 parts by weight of a carbodiimide-based chain extender;
manufacturing a recycled polyester by melting and extruding the mixture; and
spinning the recycled polyester.

12. The method of claim 11, wherein the spinning is performed at a temperature of 260 °C to 300 °C.

13. The method of claim 11, wherein the spinning is performed at a speed of 100 m/min to 1,000 m/min.
